(19) United States
(12) Patent Application Publication
(10) Pub. No.: US 2015/0008140 A1
(43) Pub. Date: Jan. 8, 2015

(54) METHOD FOR FABRICATING MICROCHANNELS IN FLUID COOLED COMPONENTS

(71) Applicant: GENERAL ELECTRIC COMPANY, SCHENECTADY, NY (US)

(72) Inventors: BENJAMIN PAUL LACY, GREER, SC (US); BIN WEI, MECHANICVILLE, SC (US)

(73) Assignee: GENERAL ELECTRIC COMPANY

(21) Appl. No.: 13/934,623

(22) Filed: Jul. 3, 2013

(51) Int. Cl. B23H 3/00

(52) U.S. Cl. CPC B23H 3/00
USPC 205/686; 205/640

(57) ABSTRACT

A method for manufacturing a microchannel cooling passage in a surface of a machine component that includes: forming an elongated open channel in the surface of the machine component, the open channel comprising a cross-sectional profile having a mouth and a floor, and, defined therebetween, a middle region; inserting a corresponding elongated electrode having a directional bias into the channel; and using the electrode as a tooling piece in an electrochemical machining process, widening the middle region of the open channel.

### BACKGROUND OF THE INVENTION

The subject matter disclosed herein relates to industrial machinery, such as turbomachinery, subject to high temperatures during operation. More specifically, but not by way of limitation, the subject matter relates to surface cooling passages and the formation of surface cooling passages in hot gas path components of turbine engines, particularly turbine rotor and stator blades.

It will be appreciated that in a turbine engine, a fuel is brought together with compressed air, which is typically supplied by an axial compressor and combusted within a combustor. The thermal energy released by the combustion creates a kinetically charged flow of hot gases, which is directed through multiple stages of airfoils or blades within a turbine section of the engine. The hot gases induce the rotor blades to rotate about a central shaft, thereby converting the chemical energy of the fuel into the kinetic energy of the rotating shaft, which then may be used to drive a generator for the production of electricity or some other purpose.

Because efficiency improves at higher operating temperatures, there is a constant push for increasing temperature through the hot gas path of gas turbine engines. As a result, there is a demand for technologies that improve the resiliency of hot gas path components through this area of the engine. However, the extreme thermal and mechanical loads through the region and the limitations of available materials mean the challenge of realizing further gains is a significant one.

One manner in which thermal loads are lessoned is circulating a coolant, which is typically compressed air bled from the compressor, through the component during operation. The effectiveness of this technique has limitations. First, because the supply of coolant is compressed air that is diverted from the main gas path, its usage reduces the efficiency of the engine. Accordingly there is a push to limit its usage as much as possible. Second, the casting processes used to form rotor blades and other hot gas components is limited in how close cooling circuits may be formed to hot outer surfaces. This reduces the cooling effectiveness of the channels.

One known manner for dealing with this issue is to enclose open channels that are machined into the surface of the component after its casting. For example, the open channel may be formed and then enclosed by a surface coating. In such cases, a filler may be used to fill the channel and support the coating while it hardens. Once hardened, the filler is leached from the channel such that a hollow, enclosed cooling channel is created that is positioned very close to the surface of the component. However, while this method has been used with a certain amount of success, it will be appreciated that the filler/leaching process is time-consuming and expensive, and, because the channel is enclosed by only a layer of coating, durability issues may arise.

In a similar known method, an open channel may be formed having a narrow neck at the surface of the component that supports the coating without the need for a filler. This approach avoids the time consuming process of filling/leaching, while the narrower neck at the component surface creates a more durable product because the span distance of the coating that encloses the channel is reduced. It will be appreciated, though, that this type of channel geometry is difficult to form, which greatly complicates and increases the cost of the machining process. As such, there is a need for improved processes for manufacturing robust cooling passages positioned close to the surface of hot gas path components.

### BRIEF DESCRIPTION OF THE INVENTION

The present application thus discloses a method for manufacturing a microchannel cooling passage in a surface of a machine component that includes: forming an elongated open channel in the surface of the machine component, the open channel comprising a cross-sectional profile having a mouth and a floor, and, defined therebetween, a middle region; inserting a corresponding elongated electrode having a directional bias into the channel; and using the electrode as a tooling piece in an electrochemical machining process, widening the middle region of the open channel.

The present application further discloses a method for manufacturing a microchannel cooling passage in a surface of a hot gas path component in a gas turbine engine that includes: forming an open channel having a non-overhanging cross-sectional profile; determining a removal area and a non-removal area within walls of the formed open channel that relate to a desired overhanging cross-sectional profile; configuring an electrode for insertion into the formed open channel such that a directional bias of the electrode aligns: a) an electrically exposed region opposite the removal area of the formed open channel; and b) an electrically insulated region opposite the non-removal area of the formed open channel; and using the electrode as a tooling device to electrochemically machine the formed open channel from the non-overhanging cross-sectional profile to the overhanging cross-sectional profile.

These and other features of the present application will become apparent upon review of the following detailed description of the preferred embodiments when taken in conjunction with the drawings and the appended claims.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic diagram of an embodiment of a turbomachine system;

FIG. 2 is a perspective view of an exemplary hot gas path component, a turbine rotor blade, in which embodiments of the present invention may be used;

FIG. 3 is a perspective view of an exemplary surface on a hot gas path component in which conventional channels have been formed;

FIG. 4 is a sectional view of the channels of FIG. 3;

FIG. 5 is a front view of the channels of FIG. 3;

FIG. 6 is a front view of a conventional channels having an alternative profile;

FIG. 7 is a sectional view depicting a step of a microchannel fabrication process according to aspects of the present invention;

FIG. 8 is a sectional view depicting a step of a microchannel fabrication process according to aspects of the present invention;

FIG. 9 is a sectional view depicting a step of a microchannel fabrication process according to aspects of the present invention;

FIG. 10 is a sectional view depicting a step of a microchannel fabrication process according to aspects of the present invention;

FIG. 11 is a sectional view depicting a step of a microchannel fabrication process according to aspects of the present invention;

FIG. 12 is a sectional view depicting a step of a microchannel fabrication process according to aspects of the present invention;

FIG. 13 is a sectional view depicting a step of a microchannel fabrication process according to aspects of the present invention;

FIG. 14 is a sectional view depicting a step of a microchannel fabrication process according to aspects of the present invention;

FIG. 15 is a sectional view depicting a step of a microchannel fabrication process according to aspects of the present invention; and

FIG. 16 is a sectional view depicting a step of a microchannel fabrication process according to aspects of the present invention.

The detailed description explains embodiments of the invention, together with advantages and features, by way of example with reference to the drawings.

### DETAILED DESCRIPTION OF THE INVENTION

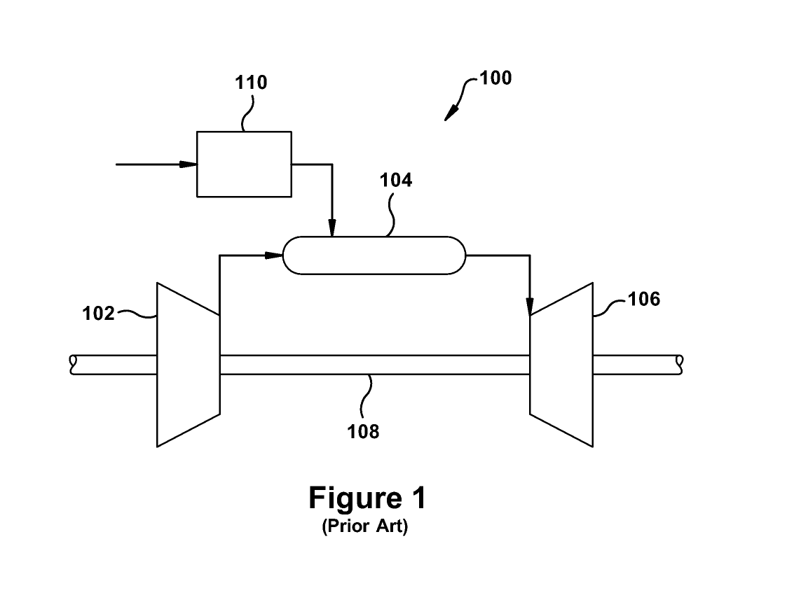

FIG. 1 is a schematic diagram of an embodiment of a turbomachine system, such as a gas turbine system 100. The system 100 includes a compressor 102, a combustor 104, a turbine 106, a shaft 108 and a fuel nozzle 110. In an embodiment, the system 100 may include a plurality of compressors 102, combustors 104, turbines 106, shafts 108 and fuel nozzles 110. The compressor 102 and turbine 106 are coupled by the shaft 108. The shaft 108 may be a single shaft or a plurality of shaft segments coupled together to form shaft 108.

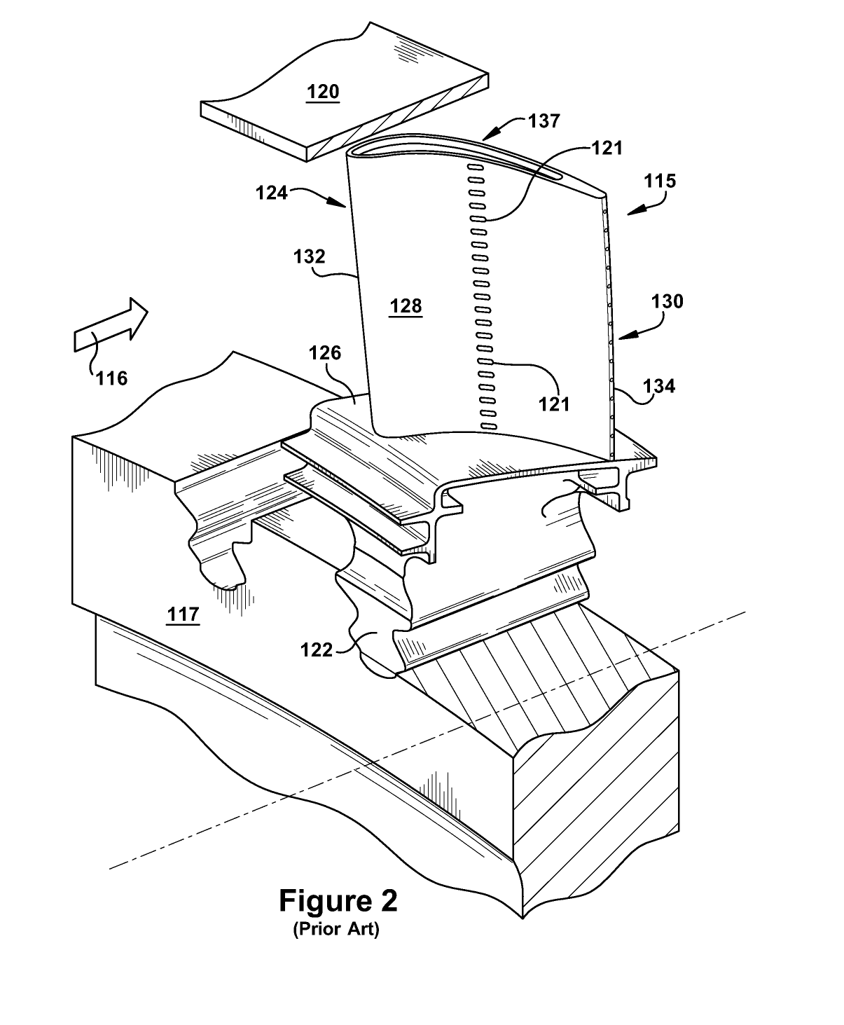

In an aspect, the combustor 104 uses liquid and/or gas fuel, such as natural gas or a hydrogen rich synthetic gas, to run the engine. For example, fuel nozzles 110 are in fluid communication with an air supply and a fuel supply 112. The fuel nozzles 110 create an air-fuel mixture, and discharge the air-fuel mixture into the combustor 104, thereby causing a combustion that creates a hot pressurized exhaust gas. The combustor 100 directs the hot pressurized gas through a transition piece into a turbine nozzle (or “stage one nozzle”), and other stages of buckets and nozzles causing turbine 106 rotation. The rotation of turbine 106 causes the shaft 108 to rotate, thereby compressing the air as it flows into the compressor 102. In an embodiment, hot gas path components, including, but not limited to, shrouds, diaphragms, nozzles, buckets and transition pieces are located in the turbine 106, where hot gas flow across the components causes creep, oxidation, wear and thermal fatigue of turbine parts. Controlling the temperature of the hot gas path components can reduce distress modes in the components. The efficiency of the gas turbine increases with an increase in firing temperature in the turbine system 100. As the firing temperature increases, the hot gas path components need to be properly cooled to meet service life. Components with improved arrangements for cooling of regions proximate to the hot gas path and methods for making such components are discussed in detail below with reference to FIGS. 2 through 15. Although the following discussion primarily focuses on gas turbines, the concepts discussed are not so limited.

FIG. 2 is a perspective view of an exemplary hot gas path component, a turbine rotor blade 115 which is positioned in a turbine of a gas turbine or combustion engine. It will be appreciated that the turbine is mounted directly downstream from a combustor for receiving hot combustion gases 116 therefrom. The turbine, which is axisymmetrical about an axial centerline axis, includes a rotor disk 117 and a plurality of circumferentially spaced apart turbine rotor blades (only one of which is shown) extending radially outwardly from the rotor disk 117 along a radial axis. An annular turbine shroud 120 is suitably joined to a stationary stator casing (not shown) and surrounds the rotor blades 115 such that a relatively small clearance or gap remains therebetween that limits leakage of combustion gases during operation.

Each rotor blade 115 generally includes a root or dovetail 122 which may have any conventional form, such as an axial dovetail configured for being mounted in a corresponding dovetail slot in the perimeter of the rotor disk 117. A hollow airfoil 124 is integrally joined to dovetail 122 and extends radially or longitudinally outwardly therefrom. The rotor blade 115 also includes an integral platform 126 disposed at the junction of the airfoil 124 and the dovetail 122 for defining a portion of the radially inner flow path for combustion gases 116. It will be appreciated that the rotor blade 115 may be formed in any conventional manner, and is typically a one-piece casting. It will be seen that the airfoil 124 preferably includes a generally concave pressure sidewall 128 and a circumferentially or laterally opposite, generally convex suction sidewall 130 extending axially between opposite leading and trailing edges 132 and 134, respectively. The sidewalls 128 and 130 also extend in the radial direction from the platform 126 to a radially outer tip or blade tip 137. A number of surface outlets 121 may be positioned on the airfoil and provide an outlet for coolant being circulated through the rotor blade.

Further, the pressure and suction sidewalls 128 and 130 are spaced apart in the circumferential direction over the entire radial span of airfoil 124 to define at least one internal flow chamber or channel for channeling cooling air through the airfoil 124 for the cooling thereof. Cooling air is typically bled from the compressor in any conventional manner. The inside of the airfoil 124 may have any configuration including, for example, serpentine flow channels with various turbulators therein for enhancing cooling air effectiveness, with cooling air being discharged through various holes through airfoil 124 such as conventional film cooling holes and/or trailing edge discharge holes. It will be appreciated that such inner cooling passages may be configured or used in conjunction with the surface cooling channels of the present invention via machining an passage that connects the inner cooling passage to the formed surface channel. This may be done in any conventional manner. In addition, as discussed in more detail below, surface channels according to the present invention may be formed to intersect existing coolant outlets such that, once the surface channel is enclosed, the pressurized coolant forces the flow of coolant through the surface channel. The rotor blade assembly of FIG. 2, as stated, is exemplary, and not intended to foreclose usage of the present invention on other turbine components or components in other industrial machinery. In the case of the rotor blade 115 of FIG. 2, it will be appreciated that the surface cooling channels of the present invention may be employed on any component that contacts the hot gases of the flow path through the turbine, including, for example, the airfoil, stationary airfoils, the platform, the shroud, endwalls, the blade tip, etc.

As discussed above, microchannel cooling has the potential to significantly reduce cooling requirements by placing the cooling as close as possible to the surface heat zone, thus reducing the temperature difference between the hot side and cold side for a given heat transfer rate. However, current techniques for forming microchannels typically require the use of a sacrificial filler to keep the coating from being deposited within the microchannels, to support the coating during deposition, as well as the removal of the sacrificial filler after deposition of the coating system. However, both the filling of the channels with a filler material, and the later removal of that material present potential problems for current microchannel processing techniques. For example, the filler must be compatible with the substrate and coatings, yet have minimal shrinkage, but also have sufficient strength. Removal of the sacrificial filler involves potentially damaging processes of leaching, etching, or vaporization, and typically requires long times. Residual filler material is also a concern.

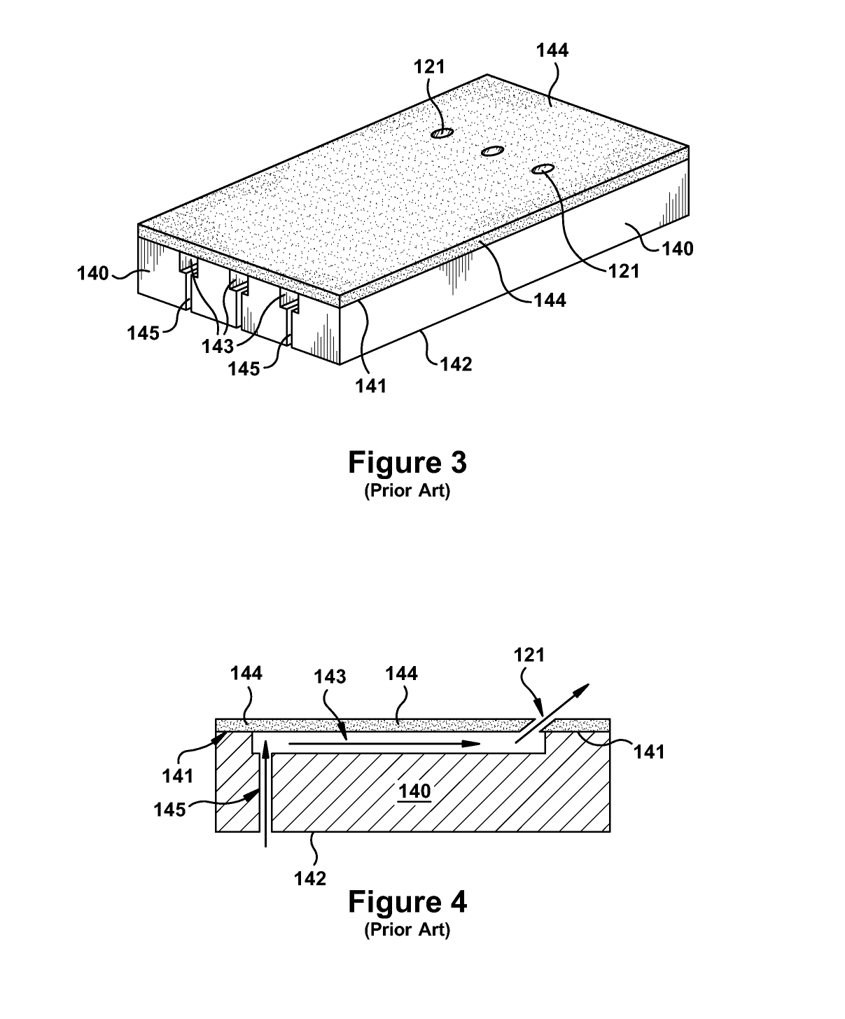

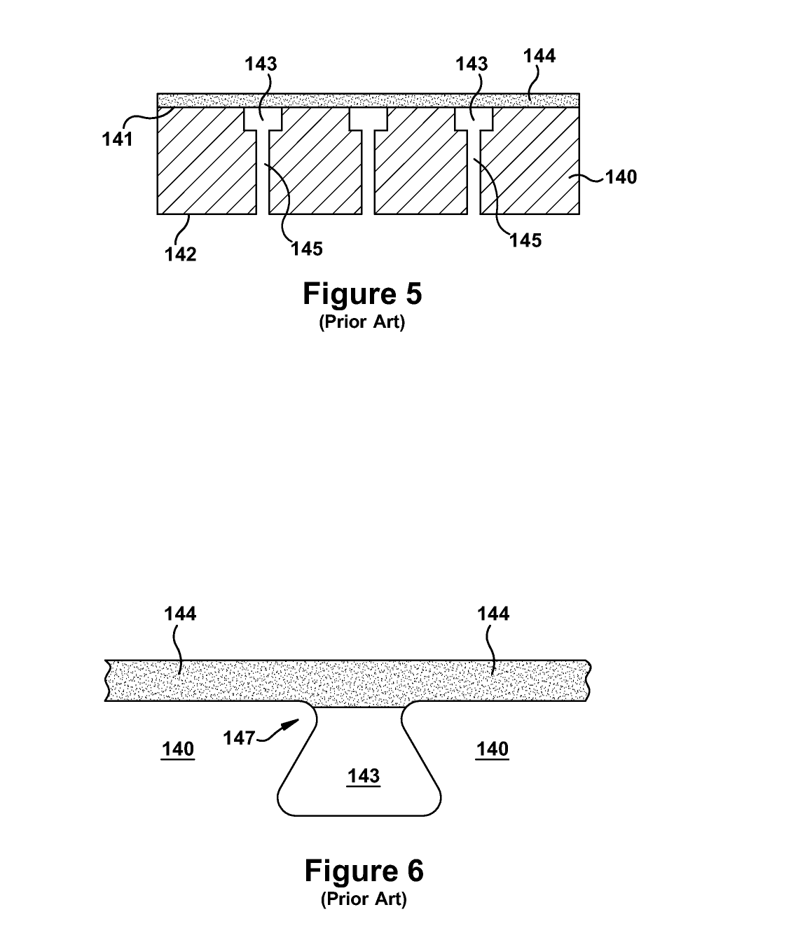

FIGS. 3, 4 and 5 illustrate a conventional microchannel 143 configuration. As shown, a hot gas path component wall 140 may have a hot side 141 that faces the hot gas path and an opposing cold side 142 from which a supply of coolant is fed via supply feeds 145. Several microchannels 143 may be formed beneath a covering or coating 144, such as a thermal barrier coating. The microchannels 143 may extend between the feeds 145 and surface outlets 121. As shown most clearly in FIG. 5, the size of the microchannels 143 is limited because of the length of the span the coating 144 covers so to enclose the channel. As used herein, the configuration of the microchannel 143 in FIG. 5 is deemed as one having a “non-overhanging configuration” because the wall at the mouth portion of the microchannel 143 does not taper or overhang the wall of the interior portions of the channel 143. That is, the walls 140 of the microchannel 143 do not taper toward a narrower mouth. It will be appreciated that FIG. 6 illustrates a microchannel 143 having a narrowed-mouth or overhanging cross-sectional configuration 147. This type of configuration is useful in that, as described, it creates a more robust channel covering while still allowing for adequate flow volume within the formed microchannel 143.

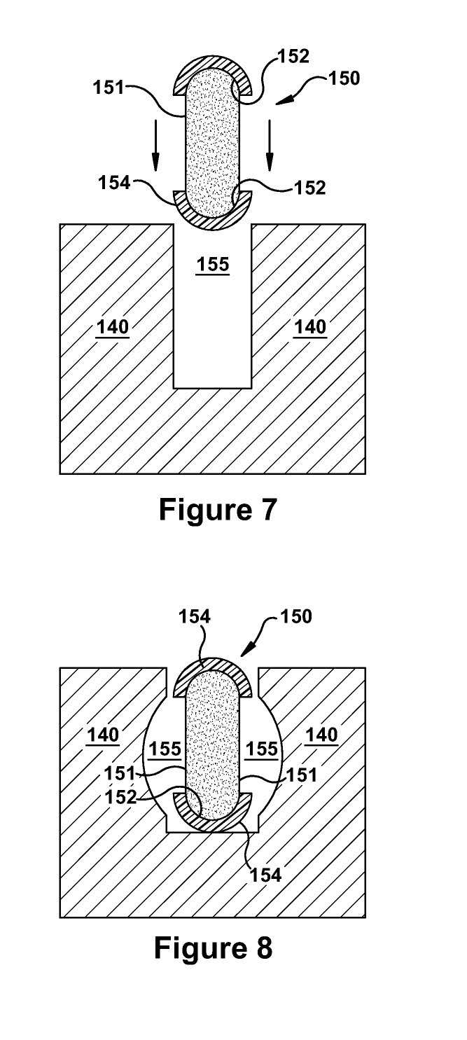

As mentioned, an overhanging profile that creates a narrowed-mouth may be used to avoid the need for filler during the coating process, as the narrowed-mouth of the overhanging profile creates a narrowed mouth that the coating can bridge without further support. As such, this approach avoids the time consuming process of filling/leaching, while the narrower neck at the component surface creates a more durable product by shortening the span distance of the coating that encloses the channel. It will be appreciated, though, that this type of channel geometry is difficult to form in the casting process because of necessary tolerances between the core and the surface of the component. Further, conventional post-cast machining processes are unable to form such geometries without greatly complicating and increasing the cost of the necessary machining. As discussed below in relation to FIGS. 7 through 16, the present invention describes an improved process by which a narrowed-mouth/overhanging microchannel configuration may be formed in an efficient and cost-effective method.

Methods according to the present invention include an electrochemical machining process (“ECM”). Unless otherwise stated, any type of ECM may be used that is able to meet the functionality described below. As will be appreciated, an ECM system typically includes a power supply, a cathode or tooling piece (depicted as wall 140 below), an anode or workpiece (depicted as tooling piece or electrode 150), an electrolyte pump, and an electrolyte tank. In operation, as one of ordinary skill in the art will appreciate, the tooling piece and the workpiece are positioned (and repositioned as the machining process continues) such that a relatively narrow inter-electrode gap is defined by the space between them. The power supply is then used to apply a voltage across the workpiece and tooling piece, i.e., the anode and cathode, respectively, of the electrolytic cell that is formed. The ECM system may include an electrolyte system, which, as shown, operates to pump a continuous stream of pressurized electrolyte into the inter-electrode gap. A suitable electrolyte, for example, aqueous sodium chloride (table salt) solution, is chosen so that the shape of the tooling piece remains substantially unchanged during the machining process. The electrolyte is pumped from an electrolyte tank and delivered to the tooling piece at a relatively high rate and pressure. The tooling piece must be positioned such that the necessary inter-electrode gap is maintained between it and the workpiece as the machining process continues. This generally includes a control system that gradually moves the tooling piece toward the workpiece as it is being machined. This may include movement along a single axis or two axes. It will be appreciated that the present invention includes using a tooling piece electrode having a specific configuration. Unless otherwise stated, the other components of the ECM system of the present application may include any conventional form that adheres to the functionality described herein.

In operation, metal removal is achieved by electrochemical dissolution of the anodically polarized workpiece, which, as stated, is one part of an electrolytic cell in ECM. Hard metals can be shaped electrolytically by using ECM and the rate of machining generally does not depend on their hardness. The tooling piece, i.e., the other electrode in the electrolytic cell in ECM, used in the process does not wear, and therefore, soft metals may be used as tools to form shapes on harder workpieces, unlike conventional machining methods. As one of ordinary skill in the art will appreciate, ECM may be used to smooth surfaces, drill holes, form complex shapes, and remove fatigue cracks in steel structures. The rate at which metal is removed from the anode (i.e., the workpiece) is approximately in inverse proportion to the distance between the electrodes. As machining proceeds, and with the simultaneous movement of the cathode at a typical rate toward the anode, the width of the inter-electrode gap along the electrode length will gradually tend to a steady-state value. A typical gap width may be about 0.0004 meters.

Turning now to FIGS. 7 through 16, methods for manufacturing a microchannel cooling passage in accordance with the present invention are depicted. Such microchannels may be formed in the surface of a hot gas path component in a gas turbine engine or other industrial machine. In certain embodiments, the microchannel 157 may be formed in a stator blade or rotor blade of a gas turbine engine.

In one preferred embodiment, as shown in FIGS. 7 through 9, the method includes the steps of: a) forming an elongated open channel 155 in the surface of the machine component, where the open channel 155 includes a cross-sectional profile having a mouth and a floor, and, defined therebetween, a middle region; b) inserting a corresponding elongated tooling piece or electrode 150 that has a directional bias into the open channel 155; and c) using the electrode 150 as a tooling piece in an electrochemical machining process, widening the middle region of the open channel 155. As illustrated in FIG. 7, the middle region of the open channel 155 includes opposing sidewalls. The electrode 150 may include a cross-sectional profile that, upon insertion into the open channel 155, includes a proximal end residing at the mouth of the open channel 155, a distal end residing at the floor of the channel 155, and opposite side surfaces that extend between the floor and the mouth of the channel 155.

As illustrated, the cross-sectional profile of the directionally biased electrode 150 includes at least one exposed region 151 and one insulated region 152. It will be appreciated that the exposed region 151 is one in which an electrical conducting surface of the electrode 150 is not covered by an electrically insulating material. The insulated region 152 is one in which an electrically insulating material covers the electrical conducting surface of the electrode 150. Any appropriate conventional electrically insulating material may be used. In one embodiment, as illustrated in FIGS. 7 and 8, the insulated region 152 is the area at the near or proximal end and the area at the far or distal end of the electrode 150, and the exposed region 151 is the area on each of the opposite side surfaces of the electrode 150. In an alternative embodiment (not shown), only one of the side surfaces may be exposed.

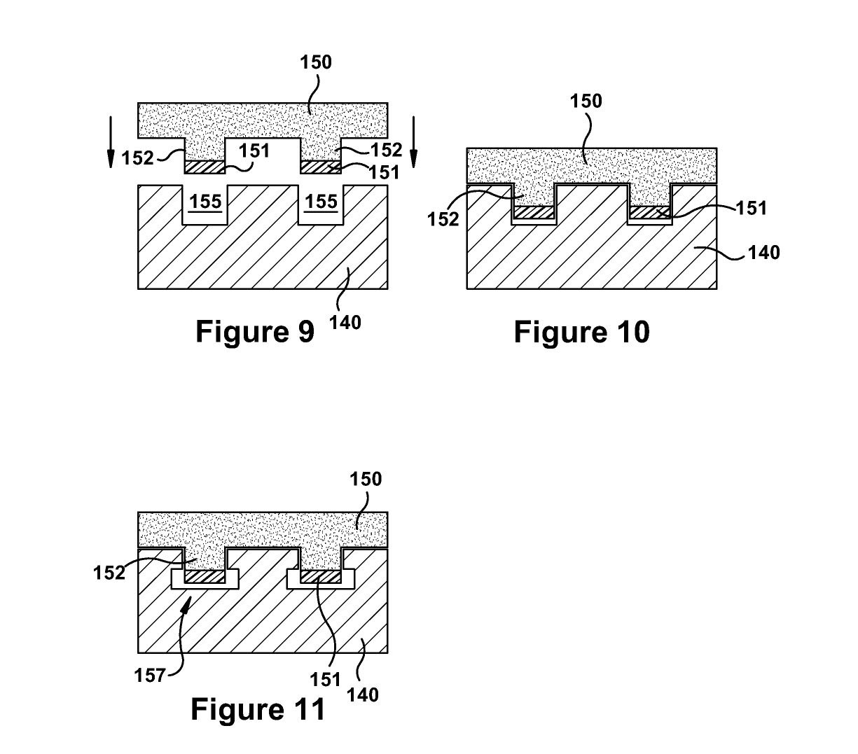

In another embodiment, as illustrated in FIGS. 9 through 16, the exposed region 151 is the area at the distal end of the electrode 150, and the insulated region 152 includes an area at the proximal end of the electrode 150. In such cases, as shown, the exposed region 151 may also include a band adjacent to the distal end of the electrode 150.

The step of forming the elongated open channel 155 may include any conventional machining or casting process. For example, the open channel 155, because of its simple profile, may be mechanically machined in a cost-effective manner. In other cases, as discussed below, the open channel 155 may be formed via an electrochemical machining process. The open channels 155 may also be cast into the component when the component is formed.

As part of one preferred embodiment, the step of forming the elongated open channel 155 includes forming a plurality of parallel elongated open channels 155. In this case, the step of inserting the corresponding elongated electrode 150 having a directional bias may include inserting a corresponding plurality of elongated electrodes 150 having a directional bias into the plurality of parallel elongated open channels 155. As illustrated in FIGS. 9 through 16, it will be appreciated that the electrodes 150 may be fixedly attached in parallel to each other so to speed the process by machining the channels 155 concurrently. This method also promotes a desired channel alignment during the machining process.

Pursuant to the present invention, another step of the fabrication process may include applying a coating 144 to enclose the machined channel 155. Additionally, at one end of the channel 155, a supply feed 145 may be formed per any conventional method. Opposite the supply feed 145 at the other end of the channel 155, a surface outlet 121 may be formed through the coating 144 that allows cooling fluid to exit the channel 155 once it passes therethrough.

Pursuant to another preferred embodiment, a method of the present invention includes the steps of: forming an open channel 155 having a non-overhanging cross-sectional profile; determining a removal area and a non-removal area within a wall of the formed open channel 155 that relate to a desired overhanging cross-sectional profile for a post-machining open channel 155; configuring an electrode 150 for insertion into the formed open channel 155 so that a directional bias of the electrode 150 aligns such that: a) an electrically exposed region 151 is opposite the removal area of the formed open channel 155, and b) an electrically insulated region 152 is opposite the non-removal area of the formed open channel 155; and then using the electrode 150 as a tooling device to electrochemically machine the formed open channel 155 from the non-overhanging cross-sectional profile to the desired overhanging cross-sectional profile. As stated, the non-overhanging cross-sectional profile of the formed open channel 155 is a configuration in which the mouth of the channel 155 has a width that is at least as wide as a greatest width within an interior of the formed open channel 155. Consistent with this, an overhanging cross-sectional profile includes a narrowed-mouth that has a width that is less than the widest section within the interior of the channel 155. Pursuant to one preferred embodiment, the overhanging profile includes a mouth having a width that is less than 50% of the greatest width within the interior of the channel 155. Accordingly, the non-removal area typically includes the area defined about the mouth of the formed open channel 155, whereas the removal area includes one or both of the sidewalls within an interior of the formed open channel 155.

The electrically biased electrode 150 may be as described above. In one preferred embodiment, as shown in FIG. 9, the biased electrode 150 includes electrically exposed region 151 in the form of a band near the distal end of the electrode. As demonstrated in FIGS. 9 through 11, in one method of construction, the electrode is positioned in the already-formed open channel 155 so that the interior lateral portions of the channel 155 are widened while the mouth, because of the insulated region 153 positioned near it, remains unaffected by the ECM process. In this manner, a channel having a non-overhanging profile may be formed efficiently using a first type of machining process and then an ECM process is employed to cost-effectively create an overhanging or narrowed-mouth profile that is preferable for enclosing with a thin coating layer that is durable in use.

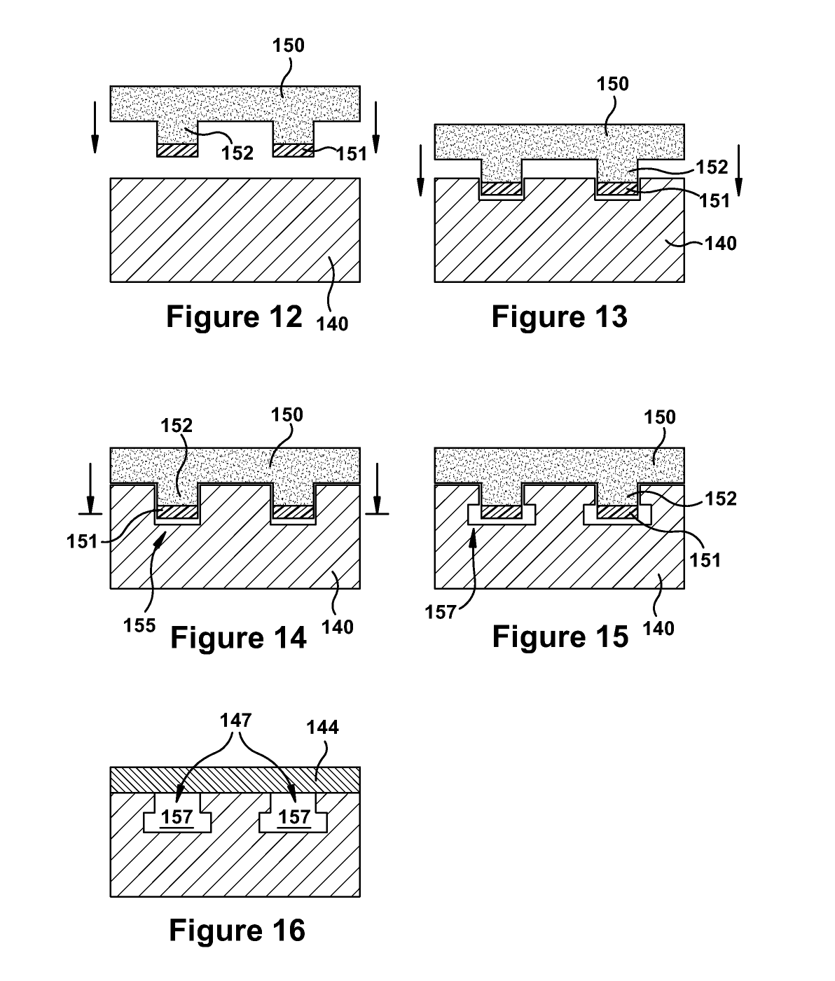

As portrayed in FIGS. 12 through 16, another embodiment of the present invention includes a method by which the open channel 155 is formed electrochemically with the same electrode that is then used to widen its interior region. In this case, the bottom surface of the electrode has an electrically exposed region 151 that is first electrochemically advanced into the surface of the component. This step is depicted in FIG. 13. This process may continue until a desired channel depth is attained. Then the electrode 150 may be halted and held in place for a period of time sufficient for electrochemical machining to widen the sides of the channel 155. During this period, it will be appreciated that an electrically exposed region 151 along the sides of the electrode 150 machine the channel 155 so to create a desired overhanding profile. This step of the process is shown in FIG. 15.

Once the widening of the channel 155 is complete, the open channel 155 then may be enclosed via a coating 144, as shown in FIG. 16, such that a surface cooling channel or microchannel 157 is fully formed. In certain preferred embodiments, the formed microchannel 157 has a maximum channel depth that is substantially constant along a length of it. According to such embodiments, the maximum channel depth may be between 0.01 and 0.1 inches. In certain preferred embodiments, the microchannel 156 has a maximum channel width through the mouth region that is substantially constant along its length. According to such embodiments, this maximum channel width through the mouth region is between 0.005 and 0.1 inches. In certain preferred embodiments, the microchannel 156 has a maximum channel width through the interior region that is substantially constant along its length. According to such embodiments, this maximum channel width through its interior is between 0.02 and 0.2 inches.

It will be appreciated that the above described invention enables the cost-effective fabrication of microchannels that are very close to the surface of the component, which enhances cooling capabilities, while also having the narrowed-mouth profiles that enhances the robustness of a coating enclosure. That is, by enabling the efficient construction of channels having very narrow surface openings, the channel may be covered with the least amount of difficulty, thereby lowering manufacturing costs. Additionally, overall cooling effectiveness is improved by minimizing the thickness of the cover layer of coating.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

We claim:

1. A method for manufacturing a microchannel cooling passage in a surface of a machine component, the method comprising:
forming an elongated open channel in the surface of the machine component, the open channel comprising a cross-sectional profile having a mouth and a floor, and, defined therebetween, a middle region;
inserting a corresponding elongated electrode having a directional bias into the channel; and
using the electrode as a tooling piece in an electrochemical machining process, widening the middle region of the open channel.

2. The method according to claim 1, wherein the middle region of the open channel comprises opposing sidewalls;
wherein the electrode comprises a cross-sectional profile that, upon insertion into the open channel, includes a proximal end residing at the mouth, a distal end residing at the floor, and opposite side surfaces that extend therebetween; and
wherein the cross-sectional profile of the directionally biased electrode comprises at least one exposed region and one insulated region.

3. The method according to claim 2, wherein the exposed region comprises one in which an electrical conducting surface of the electrode is not covered by an electrically insulating material, and the insulated region comprises one in which an electrically insulating material covers the electrical conducting surface of the electrode;
wherein the at least one insulated region comprises the proximal end and the distal end of the electrode; and
wherein the at least one exposed region comprises at least one of the opposite side surfaces.

4. The method according to claim 3, wherein the at least one exposed region comprises both of the opposite side surfaces.

5. The method according to claim 2, wherein the step of forming the elongated open channel comprises one of a casting process, a mechanical machining process, and an electrochemical machining process.

6. The method according to claim 2, wherein the step of forming the elongated open channel comprises using the tooling piece to electrochemically machining the open channel.

7. The method according to claim 6, wherein the at least one insulated region comprises the proximal end of the electrode; and
wherein the at least one exposed region comprises the distal end of the electrode.

8. The method according to claim 7, wherein the at least one exposed region includes a band of the side surfaces adjacent to the distal end of the electrode.

9. The method according to claim 2, wherein the step of forming the elongated open channel comprises forming a plurality of parallel elongated open channels;
wherein the step of inserting the corresponding elongated electrode having a directional bias into the channel includes inserting a corresponding plurality of elongated electrodes having a directional bias into the plurality of parallel elongated open channels, wherein the plurality of elongated electrodes are fixedly attached in parallel to each other; and
wherein the step of using the electrode as the tooling piece in the electrochemical machining process so to widening the interior region of the open channel includes using the plurality of electrodes as the tooling pieces in an electrochemical machining process so to concurrently widen the interior region of each the plurality of the open channels.

10. The method according to claim 2, further comprising the steps of:
configuring a supply feed to the open channel; and
enclosing the open channel by coating the surface of the machine component; and
configuring a surface outlet for the enclosed open channel.

11. A method for manufacturing a microchannel cooling passage in a surface of a hot gas path component in a gas turbine engine, the method comprising the steps of:
forming an open channel having a non-overhanging cross-sectional profile;
determining a removal area and a non-removal area within walls of the formed open channel that relate to a desired overhanging cross-sectional profile;
configuring an electrode for insertion into the formed open channel such that a directional bias of the electrode aligns: a) an electrically exposed region opposite the removal area of the formed open channel; and b) an electrically insulated region opposite the non-removal area of the formed open channel; and
using the electrode as a tooling device to electrochemically machine the formed open channel from the non-overhanging cross-sectional profile to the overhanging cross-sectional profile.

12. The method for manufacturing a microchannel cooling passage according to claim 11, wherein the non-overhanging cross-sectional profile of the formed open channel includes a mouth having a width at least as large as a greatest width within an interior of the formed open channel; and
wherein the overhanging cross-sectional profile includes the mouth having a width that is less than the greatest width within the interior of the formed open channel.

13. The method for manufacturing a microchannel cooling passage according to claim 12, wherein the overhanging profile includes the mouth having a width that is at less than 50% of the greatest width within the interior of the open channel; and
wherein the hot gas path component comprises one of a turbine rotor blade and a turbine stator blade.

14. The method for manufacturing a microchannel cooling passage according to claim 11, the non-removal area comprises a mouth of the formed open channel; and
wherein the removal area comprises at least one of the sidewalls within an interior of the formed open channel.

15. The method for manufacturing a microchannel cooling passage according to claim 14, wherein the electrically exposed region of the electrode comprises one in which an electrical conducting surface of the electrode is not covered by an electrically insulating material, and the electrically insulated region of the electrode comprises one in which an electrically insulating material covers the electrical conducting surface of the electrode;
wherein the removal area comprises both of the sidewalls within the interior of the open channel.

16. The method for manufacturing a microchannel cooling passage according to claim 14, wherein the electrode comprises a cross-sectional profile that, upon insertion into the open channel, includes a proximal end residing at the mouth, a distal end residing at the floor, and opposite side surfaces that extend therebetween;
wherein the electrically insulated region comprises the proximal end and the distal end; and
wherein the electrically exposed region of the electrode includes side surfaces positioned between the proximal end and the distal end of the electrode.

17. The method for manufacturing a microchannel cooling passage according to claim 14, wherein the electrode comprises a cross-sectional profile that, upon insertion into the open channel, includes a proximal end residing at the mouth, a distal end residing at the floor, and opposite side surfaces that extend therebetween;
wherein the electrically insulated region comprises the proximal end of electrode and a first band of the side surfaces adjacent thereto; and
wherein the electrically exposed region comprises the distal end of the electrode and a second band of the side surfaces adjacent thereto.

18. The method for manufacturing a microchannel cooling passage according to 17, wherein the step of forming the open channel includes electrochemically machining the open channel using the distal end of the electrode.

19. The method for manufacturing a microchannel cooling passage according to claim 18, further comprising the steps: advancing the electrode into the surface of the hot gas path component as the open channel is electrochemically machined until reaching a first position that corresponds to a desired channel depth;
halting further advancement of the electrode into the surface of the hot gas component once the first position is reached; and
holding the electrode at the first position while continuing the electrochemical machining so to widen the sidewalls opposite the electrically exposed region of the second band of the electrode so to widen the sidewalls.

20. The method for manufacturing a microchannel cooling passage according to claim 14, further comprising the step of coating the surface of the machine component so to substantially enclose the open channel;
wherein once the overhanging cross-sectional profile is achieved:
a maximum channel depth is substantially constant along a length of the open channel, is between 0.01 and 0.1 inches;
a maximum channel width through the mouth region of the open channel is substantially constant along the length of the open channel, and is between 0.005 and 0.1 inches;
a maximum channel width through the interior of the open channel is substantially constant along the length of the channel, and is between 0.02 and 0.2 inches.
